(19) United States
(12) Patent Application Publication
(10) Pub. No.: US 2008/0201514 A1
(43) Pub. Date: Aug. 21, 2008

(54) Method of locating peripheral component interconnect devices

(75) Inventors: Tao Liu, Tianjin (CN); Gang Zhou, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/708,491

(22) Filed: Feb. 21, 2007

(51) Int. Cl. G06F 13/36

(52) U.S. Cl. 710/311

(57) ABSTRACT

A method of locating peripheral component interconnect (PCI) devices is provided. The method includes analyzing peripheral component interconnect spaces (PCI spaces) of peripheral component interconnect-peripheral component interconnect bridges (PCI-PCI bridges) of a 0-numbered bus, so as to obtain a bus number of a next bus connected to each of PCI-PCI bridges and record the bus number in a linked list; continuing to record a bus number of a next bus connected to the PCI-PCI bridges corresponding to the bus number recorded in the linked list; and when no next bus number is found, traversing and locating the PCI devices according to all of the bus numbers recorded in the linked list.

### BACKGROUND OF THE INVENTION

1. Field of Invention

The present invention relates to a method of locating peripheral component interconnect (PCI) devices, and more particularly, to a method of locating PCI devices through PCI bridges.

2. Related Art

Generally speaking, in many systems, the traversal of PCI devices is a basic functional requirement. However, a system architecture allows the existence of multiple buses. Each of the buses connects multiple devices, and each of the devices has multiple function digits. For example, if a system has 256 buses, each of the buses connects 32 devices, and each of the devices has 8 function numbers, when being initialized, the system will reserve an address space for each possible device. In other words, the system reserves address spaces for 256×32×8=65,536 PCI devices regardless of whether all of the devices are actually in existence.

Generally, the number of the actually existing devices in the system is far smaller than the aforementioned number, and then, these actually existing PCI devices may occupy any resources in the 65536 address spaces, leading to a result that a user is unable to know which bus that a device is actually connected to in advance. Therefore, if the actually existing PCI devices in the system need to be traversed, the buses of all of the PCI devices in the system must be traversed, that is, traversed for 65536 times, requiring much time correspondingly. If in a test, the traversing time will be more unacceptable. Therefore, although the traversal method of the PCI devices is a typical method specified in a PCI specification, it is infeasible in practice.

Furthermore, in fact, the system does not include so many PCI devices, and thus, the PCI devices are allocated with bus numbers not more than 100. However, not all of the bus numbers of the devices are continuous, and the PCI devices corresponding to discontinuous bus numbers or the PCI devices exceeding the range of the allocated bus numbers cannot be located allsidedly.

### SUMMARY OF THE INVENTION

In order to solve the problems and defects in the conventional art, the present invention is directed to providing a method of locating PCI devices, so as to ensure the accuracy and allsidedness of the traversal of the PCI devices and enhance the efficiency of locating the devices.

The method of locating PCI devices provided by the present invention includes analyzing PCI spaces of PCI-PCI bridges of a 0-numbered bus, so as to obtain a bus number of a next bus connected to each of the PCI-PCI bridges, and to record the bus number in a linked list; continuing to record a bus number of a next bus connected to the PCI-PCI bridges corresponding to the bus number recording in the linked list; and when no next bus number is found, traversing and locating the corresponding PCI devices according to all of the bus numbers recorded in the linked list.

In the present invention, by accessing and analyzing the PCI-PCI bridges, the maximum bus depth of each of the PCI-PCI bridges and the maximum bus number caused by the PCI-PCI bridges are obtained. Therefore, the range of the buses that are to be traversed can be set in a flexible way, so as to locate the PCI devices corresponding to the buses allsidedly, accurately, and rapidly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of the connection between the buses and the PCI-PCI bridges; and

FIG. 2 is a flow chart of the steps of the method of locating the PCI device provided by the present invention.

### DETAILED DESCRIPTION OF THE INVENTION

The features and practice of the preferred embodiments of the present invention will be illustrated below in detail with reference to the drawings.

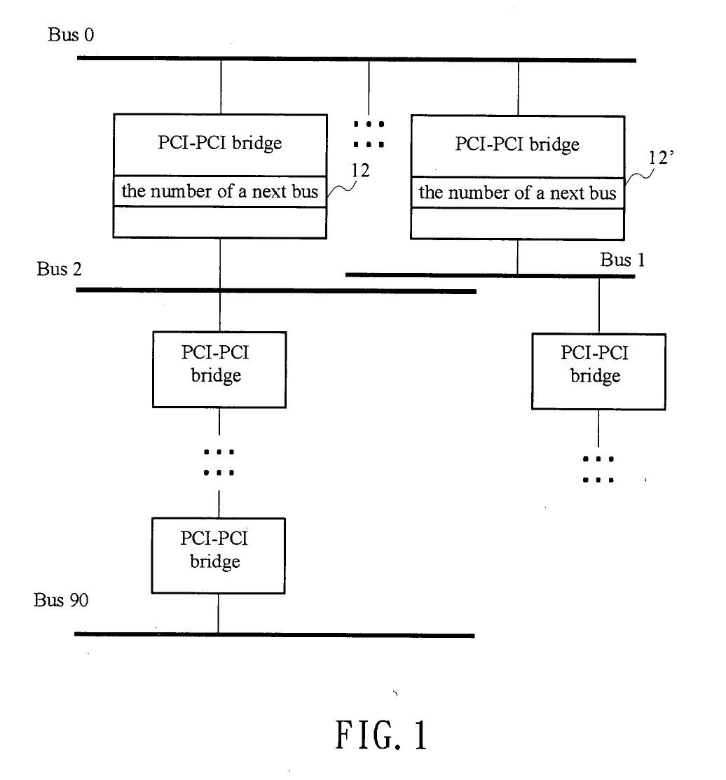

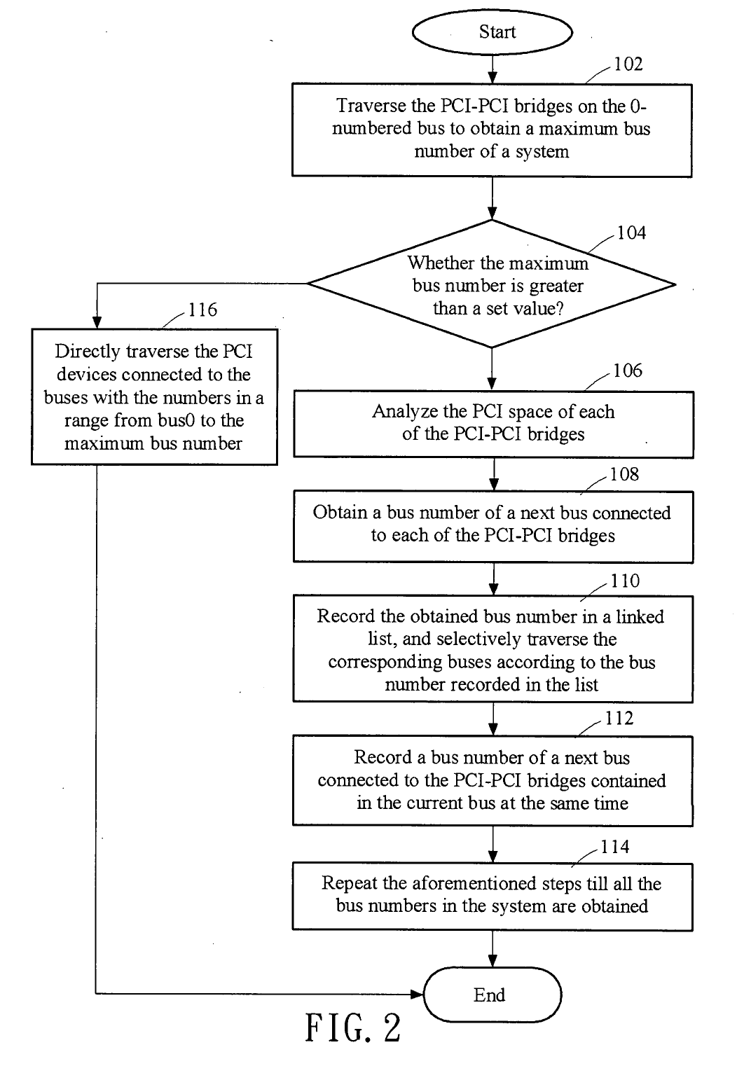

FIG. 1 shows the connection between the buses and the PCI-PCI bridges, FIG. 2 is a flow chart of the steps of the method of locating PCI devices provided by the present invention.

Referring to FIG. 1, each of the systems has a 0-numbered bus, i.e., bus0. All buses starts from bus0, and as shown in FIG. 1, the buses are connected through the PCI-PCI bridges.

Referring to FIG. 2, the steps of the method of locating the PCI devices provided by the present invention are described in detail. Firstly, the PCI-PCI bridges on the bus0 are traversed to obtain a maximum bus number in the system (Step 102). The system performs resource allocation on the buses when being booted, and through accessing the PCI-PCI bridges, the system can know the maximum bus depth of each of the PCI-PCI bridges, and obtain the maximum bus number caused by the corresponding PCI-PCI bridges.

After the maximum bus number of the system is obtained, a determination step is performed to determine whether the maximum bus number is greater than a set value (Step 104). Through this step, when the bus number is allocated in a small range, for example, the set value is 30, the PCI devices connected to the buses from bus0 to the bus with the maximum bus number are directly traversed to locate the devices (Step 116). When the maximum bus number is greater than a set value, i.e., the maximum bus number of the system is too great, the PCI devices on bus0 are firstly traversed, and the spaces of all of the PCI-PCI bridges on bus0 are analyzed (Step 106). That is, a third double byte of the space offset of the PCI devices is obtained through operating a system port. The displacement operation is performed on the obtained data, and if the obtained data is 0×0604, the fourth offset double byte is obtained on the basis of this, and the corresponding data is obtained through operating the obtained data. Then, the bus number of a next bus connected to each of the PCI-PCI devices is obtained (Step 108). For example, the PCI-PCI bridges 12 and 12′ in FIG. 1 are analyzed to obtain the corresponding next bus numbers sequentially. Subsequently, the obtained bus numbers are recorded in a linked list, and the buses corresponding to the bus numbers recorded in the linked list are selectively traversed (Step 110). Meanwhile, the number of a next bus connected to the PCI-PCI bridges contained in the currently traversed bus is recorded (Step 112). Steps 110 and 112 are repeated till all bus numbers in the system are obtained (Step 114). In a similar way, all the actually existing bus numbers are obtained and the PCI devices are located rapidly.

For example, the system has 256 buses, each of the buses connects 32 devices, and each of the devices has 8 function numbers, i.e., the system possibly has 256×32×8=65536 PCI devices. Provided that only 6 PCI devices are actually connected in the system, and are present on bus 0, bus 1, bus 2, bus 4, bus 9, and bus 90 respectively, during a test, the traverse should be performed 65536 times, and about 15 minutes are required according to the conventional art.

The present invention has an advantage that the buses to be traversed can be selectively traversed. This is because two buses are connected by a PCI-PCI bridge. When the system is initialized, a part of the information of the next bus connected to the PCI-PCI bridge is stored in the PCI space, and all buses (except for Bus 0) are connected from Bus0 directly or indirectly through the PCI-PCI bridges. Therefore, the PCI-PCI bridges are traversed gradually from BusO to obtain the buses actually existing in the system. During traversal, only the buses actually connecting the devices need to be traversed.

Therefore, still using the aforementioned example, Bus 1, Bus 4, and Bus 9 are directly connected to Bus 0 through the PCI-PCI bridges respectively, Bus1 is further connected to Bus 2 through a PCI-PCI bridge, and Bus 9 is connected to Bus 90 through a PCI-PCI bridge. Then, during the traversal, three PCI-PCI bridges are traversed on Bus0, and through analyzing the PCI spaces of the PCI-PCI bridges, it can be seen that the three PCI-PCI bridges are connected to Bus 1, Bus 4, and Bus 9, respectively. Then, after the three buses are further traversed, it is found that a PCI-PCI bridge is present on Bus1 and Bus9 respectively, and is connected to Bus 2 and Bus 90 respectively. Afterwards, the PCI-PCI bridges are traversed on Bus 2 and Bus 90, respectively. If no PCI-PCI bridges are found, it is known that the system has six buses in total, namely, Bus 0, Bus 1, Bus 2, Bus 4, Bus 9, and Bus 90. Therefore, during the test, by using the present invention, the traverse is performed at most 6×32×8=1536 times, and about 20 seconds are spent. The PCI method provided by the present invention not only ensures the accuracy and allsidedness of the traversal, but also saves test time, thereby enhancing testing efficiency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of locating peripheral component interconnect devices, comprising:
analyzing peripheral component interconnect spaces (PCI spaces) of peripheral component interconnect-peripheral component interconnect bridges (PCI-PCI bridges) of a 0-numbered bus, so as to obtain a bus number of a next bus connected to each of PCI-PCI bridges, and record the bus number in a linked list;
continuing to record a bus number of a next bus connected to the PCI-PCI bridge corresponding to the bus number recorded in the linked list; and
traversing and locating the PCI devices according to all of the bus numbers recorded in the linked list when no next bus number is found.

2. The method of locating peripheral component interconnect devices as claimed in claim 1, further comprising a step of traversing the PCI-PCI bridges contained in the 0-numbered bus, so as to obtain a maximum bus number in a system.

3. The method of locating peripheral component interconnect devices as claimed in claim 2, further comprising a step of directly traversing the PCI devices connected to the buses with the numbers from 0 to the maximum number when the maximum bus number is smaller than a set value.
